(19) United States
(12) Patent Application Publication
(10) Pub. No.: US 2021/0305620 A1
(43) Pub. Date: Sep. 30, 2021

(54) LITHIUM ION SECONDARY BATTERY

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/206,101

(22) Filed: Mar. 18, 2021

(30) Foreign Application Priority Data
Mar. 25, 2020 (JP) 2020-053669

(51) Int. Cl. H01M 10/0525; H01M 4/70; H01M 4/66; H01M 4/04; H01M 4/38; H01M 4/505; H01M 4/525; H01M 4/58

(52) U.S. Cl. CPC H01M 10/0525; H01M 4/70; H01M 4/667; H01M 4/0404; H01M 2004/027; H01M 4/505; H01M 4/525; H01M 4/58; H01M 4/382

(57) ABSTRACT

A lithium ion secondary battery that, when current collector tabs of the lithium ion secondary battery are bundled together and joined with a lead terminal, can prevent the current collector tabs from cracking or breaking and can ensure that both of an electrical connection and a physical connection between the current collector tabs and the lead terminal are guaranteed is provided.

This application is based on and claims the benefit of priority from Japanese Patent Application No. 2020-053669, filed on 25 Mar. 2020, the content of which is incorporated herein by reference.

### BACKGROUND OF THE INVENTION

### Field of the Invention

The present invention relates to a lithium ion secondary battery.

### Related Art

In recent years, lithium ion secondary batteries have been widely used as secondary batteries that have high energy density. A lithium ion secondary battery has a structure in which a solid electrolyte (separator) is caused to be present between a positive electrode and a negative electrode, and the rest of the structure is filled with a liquid electrolyte (electrolytic solution).

The electrolytic solution in a lithium ion secondary battery is normally a flammable organic solvent, and thus there are cases where safety with respect to heat in particular is a problem. Accordingly, solid-state batteries that use an inorganic solid electrolyte in place of the organic liquid electrolyte have been proposed (refer to Patent Document 1).

In comparison to batteries that use an electrolytic solution, solid-state batteries that use a solid electrolyte can resolve the problem with heat, and meet demand for higher capacity and higher voltages via lamination.

Solid-state batteries can also contribute to having a more compact size.

In a lithium ion secondary battery that uses either a liquid electrolyte or a solid electrolyte, a positive electrode that includes a positive electrode current collector, a solid electrolyte, and a negative electrode that includes a negative electrode current collector are repeatedly laminated. A plurality of current collector tabs are drawn in the same direction from the positive electrodes, a plurality of current collector tabs are drawn in the same direction from the negative electrodes, and each plurality of current collector tabs is subsequently bundled together and then connected to a lead terminal to thereby be integrated with an exterior body.

FIGS. 7A and 7B are views that illustrate a state in which a lead terminal is joined to a conventional lithium ion secondary battery main body.

As illustrated in FIG. 7A, a plurality of current collector tabs 12a, 12b, 12c, and 12d that are drawn from a lithium ion secondary battery main body 100 are bundled together and subsequently joined by welding to a lead terminal 200 at a joint section 600.

At this time, because each current collector tab is a thin foil whereas the lead terminal is thick and plate-shaped, when the strength of the joint with the lead terminal is prioritized in order to strengthen welding conditions, the current collector tabs are more likely to crack or break, making it impossible to guarantee an electrical connection.

Conversely, when the strength of joints between current collector tabs is prioritized thereby weakening the welding conditions, the strength of the joint between the lead terminal and the current collector tabs weakens and it becomes impossible to guarantee the physical strength of the joint.

In this fashion, subtle adjustment of the welding conditions is necessary, and it has been difficult to ensure that both of an electrical connection and a physical connection between the lead terminal and the current collector tabs are guaranteed.

This is particularly conspicuous when the position of the lead terminal 200 has shifted lower than the center as illustrated in FIG. 7B.

In this case, because the highest tension is applied to the topmost current collector tab 12a, the current collector tab 12a is particularly likely to crack or break.

Patent Document 1: Japanese Unexamined Patent Application, Publication No. 2000-106154

### SUMMARY OF THE INVENTION

The present invention is made in light of the background art described above, and an object of the present invention is to provide a lithium ion secondary battery that, when current collector tabs of the lithium ion secondary battery are bundled together and joined with a lead terminal, can prevent the current collector tabs from cracking or breaking and can ensure that both of an electrical connection and a physical connection between the current collector tabs and the lead terminal are guaranteed.

In order to solve all of the abovementioned problems at the same time, the inventors, as a result of diligently considering methods of connecting current collector tabs and lead terminals in lithium ion secondary batteries, discovered that it was possible to solve the abovementioned problems by dispersing the location where a plurality of bundled current collector tabs are joined to a lead terminal among two or more locations, and have accomplished the present invention. Specifically, the following aspects are provided.

(1) A lithium ion secondary battery provided with: a lithium ion secondary battery main body that is a laminate in which a positive electrode having a positive electrode current collector, an electrolyte, and a negative electrode having a negative electrode current collector are repeatedly arranged, respective current collectors of at least one of the positive electrodes and the negative electrodes being drawn in respectively the same direction from an end surface of the laminate and configuring a plurality of current collector tabs;

a lead terminal connected to the plurality of current collector tabs after the plurality of current collector tabs are bundled together; a first joint section at which at least the bundled current collector tabs are joined to each other at a first position; and

a second joint section at which the lead terminal and the bundled current collector tabs are joined at a second position different to the first joint section.

(2) A lithium ion secondary battery provided with: a lithium ion secondary battery main body that is a laminate in which a positive electrode having a positive electrode current collector, an electrolyte, and a negative electrode having a negative electrode current collector are repeatedly arranged, respective current collectors of at least one of the positive electrodes and the negative electrodes being drawn in respectively the same direction from an end surface of the laminate and configuring a plurality of current

collector tabs; a lead terminal connected to the plurality of current collector tabs after the plurality of current collector tabs are bundled together; a first joint section at which at least the bundled current collector tabs are joined to each other and one end side of a connection member at a first position; and

a second joint section at which the other end side of the connection member and the lead terminal are joined at a second position different to the first joint section.

(3) The lithium ion secondary battery according to (2), wherein the connection member is a welding tip.

(4) The lithium ion secondary battery according to (2) or (3), wherein the connection member is a plate-like member having a step at an approximate center of the connection member.

(5) The lithium ion secondary battery according to (2) or (3), wherein the connection member is a plate-like member that has flexibility.

(6) The lithium ion secondary battery according to any one of claims 2) to (5), wherein the thickness of the one end side of the connection member is thinner than the thickness of the other end side.

(7) The lithium ion secondary battery according to any one of (2) to (6), wherein a joint surface is arranged at one end side of the lead terminal so as to face the end surface of the laminate, and a plurality of the second position are provided on the joint surface, and each current collector tab is distributed so as to be connected to a nearby second position, either directly or through the connection member.

The lithium ion secondary battery according to (7), wherein the one end side of the lead terminal branches into a plurality of branch destinations, and the plurality of second positions are provided on the plurality of branch destinations.

By virtue of the present invention, it is possible to, when bundling current collector tabs of a lithium ion secondary battery and joining the bundled current collector tabs to a lead terminal, prevent cracks in the current collector tabs, and ensure that both of an electrical connection and a physical connection with the lead terminal are guaranteed.

### BRIEF DESCRIPTION OF THE DRAWINGS

FIG. 1 is a schematic side cross-sectional view that illustrates a state in which a lead terminal is joined to a lithium ion secondary battery main body according to a first embodiment of the present invention.

FIG. 2 is a side cross-sectional view of the lithium ion secondary battery main body according to the first embodiment of the present invention.

FIG. 3 is a schematic side cross-sectional view that illustrates a state in which a lead terminal is joined to a lithium ion secondary battery main body according to a second embodiment of the present invention.

FIG. 4 is a schematic side cross-sectional view that illustrates a state in which a lead terminal is joined to a lithium ion secondary battery main body according to a third embodiment of the present invention.

FIG. 5A is a schematic side cross-sectional view that illustrates a state in which a lead terminal is joined to a lithium ion secondary battery main body according to a fourth embodiment of the present invention.

FIG. 5B is a schematic perspective view that illustrates a state in which the lead terminal is joined to the lithium ion secondary battery main body according to the fourth embodiment of the present invention.

FIG. 6A is a schematic side cross-sectional view that illustrates a state in which a lead terminal is joined to a lithium ion secondary battery main body according to a fifth embodiment of the present invention.

FIG. 6B is a schematic perspective view that illustrates a state in which the lead terminal is joined to the lithium ion secondary battery main body according to the fifth embodiment of the present invention.

FIG. 7A is a schematic side cross-sectional view that illustrates a state in which a lead terminal is joined to a conventional lithium ion secondary battery main body when the lead terminal is in the center.

FIG. 7B is a schematic side cross-sectional view that illustrates a state in which a lead terminal is joined to a conventional lithium ion secondary battery main body when the lead terminal is shifted downward.

### DETAILED DESCRIPTION OF THE INVENTION

With reference to the drawings, description is given below regarding embodiments of the present invention. However, the embodiments described below exemplify the present invention. The present invention is not limited to the following. The following embodiments are described by taking a lithium ion solid-state battery as an example, but the present invention is not limited to this, and includes lithium ion batteries when the electrolyte is liquid.

### <Overall Configuration of Lithium Ion Secondary Battery>

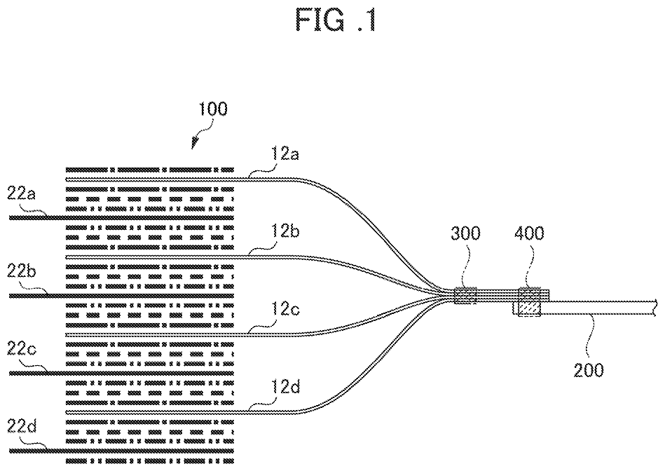

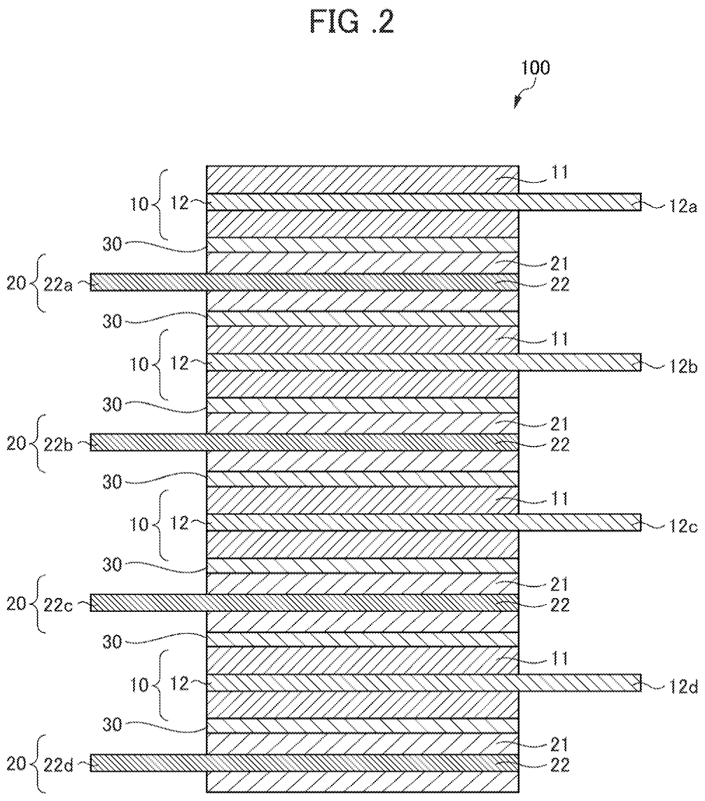

With reference to FIGS. 1 and 2, description is first given for an overall configuration of a lithium ion secondary battery according to the present invention.

FIG. 1 is a schematic side cross-sectional view that illustrates a state in which a lead terminal 200 is joined to a lithium ion secondary battery main body 100 according to a first embodiment of the present invention. FIG. 2 is a side cross-sectional view of the lithium ion secondary battery main body according to the first embodiment of the present invention.

As illustrated in FIG. 1, the lithium ion secondary battery 100 is configured by a lithium ion secondary battery main body 100 and a lead terminal 200. A plurality of current collector tabs (negative electrode current collector tabs 12a, 12b, 12c, and 12d in FIG. 2) of the lithium ion secondary battery main body 100 are bundled together and welded at two joint locations: a first joint section 300 and a second joint section 400.

As illustrated by FIG. 2, the lithium ion secondary battery main body 100 is a laminate that has a structure in which a negative electrode 10, a positive electrode 20, and a solid electrolyte layer 30 arranged therebetween are repeatedly laminated.

The present embodiment is an example in which units of lamination each consisting of the negative electrode 10, the solid electrolyte layer 30, and the positive electrode 20 are repeatedly laminated so as to be laminated a total of four times.

Each negative electrode 10 results from laminating a negative electrode active material layer 11 on both surfaces of a negative electrode current collector 12. Each positive electrode 20 results from laminating a positive electrode active material layer 21 on both surfaces of a positive electrode current collector 22.

The current collector and the active material layer may be separate layers or integrated.

### [Negative Electrode Active Material Layer]

The negative electrode active material that makes up the negative electrode active material layer 11 is not particularly limited. A material that is publicly known as the negative electrode active material of a solid-state battery can be employed as the negative electrode active material that makes up the negative electrode active material layer 11.

The composition of the positive electrode active material is not particularly limited and may include a solid electrolyte, and a conductive aid, a binder, or the like.

The negative electrode active material may be lithium metal, a lithium alloy such as a Li—Al alloy or a Li—In alloy, a lithium titanate such as Li4Ti5O12, a carbon material such as carbon fiber or graphite, or the like, for example.

### [Negative Electrode Current Collector]

The negative electrode current collector 12 is not particularly limited. A current collector that is publicly known as being able to be used for a negative electrode of a solid-state battery can be employed as the negative electrode current collector 12. For example, the negative electrode current collector 12 may be metal foil such as stainless steel (SUS) foil or copper (Cu) foil.

### [Positive Electrode Active Material Layer]

The positive electrode active material that makes up the positive electrode active material layer 21 is not particularly limited. A material that is publicly known as the positive electrode active material of a solid-state battery can be employed as the positive electrode active material that makes up the positive electrode active material layer 21.

The composition of the positive electrode active material is not particularly limited and may include a solid electrolyte, and a conductive aid, a binder, or the like.

The positive electrode active material may be a transition metal chalcogenide such as titanium disulfide, molybdenum disulfide, or niobium selenide, a transition metal oxide such as lithium nickelate (LiNiO2), lithium manganate (LiMnO2, LiMn2O4), lithium cobalt oxide (LiCoO2), or the like, for example.

### [Positive Electrode Current Collector]

The positive electrode current collector 22 is not particularly limited. A current collector that is publicly known as being able to be used for a positive electrode of a solid-state battery can be employed as the positive electrode current collector 22. For example, the positive electrode current collector 22 may be metal foil such as stainless steel (SUS) foil or aluminum (Al) foil.

### [Current Collector Tabs]

A plurality of negative electrode current collector tabs 12a, 12b, 12c, and 12d are drawn in the same direction from one end surface of the laminate in approximately parallel planar shapes.

In the present embodiment, negative electrode current collector tabs that are drawn from respective negative electrode current collectors 12 are configured.

A plurality of positive electrode current collector tabs 22a, 22b, 22c, and 22d are drawn in the same direction from the other end surface of the laminate in approximately parallel planar shapes. In the present embodiment, positive electrode current collector tabs that are drawn from respective positive electrode current collectors 22 are configured.

In the present invention, it is sufficient if the result is that the current collector tabs are drawn from respective current collectors. There is no limitation to drawing the current collector tabs, and the current collector tabs may be members that differ to the negative electrode current collectors 12.

With the width of the material mixture as a maximum, the width of a current collector tab is appropriately set so that the resistance of a current collection tab section becomes low in accordance with intended use, but is desirably 1 mm to 1000 mm, and more desirably 2 mm to 300 mm.

It is typical for the thickness to be approximately 5 to 50 pm and the drawn length to be approximately 5 to 50 mm.

### [Lead Terminal]

One end side of the lead terminal 200 is electrically connected by welding or the like to current collector tabs on the lithium ion secondary battery main body 100 side. The other end side of the lead terminal 200 extends from the exterior body, which is a laminate film or the like and is not illustrated, and configures an electrode section of the exterior body of the lithium ion secondary battery.

The lead terminal 200 is not particularly limited, and is desirably a filamentary plate-like member that has flexibility and includes aluminum (Al), copper (Cu), or the like.

The thickness of the lead terminal 200 is typically approximately 0.05 to 5 mm, and is thicker than the thickness of a current collector tab.

### <Structure of Connection Between Lithium Ion Secondary Battery Main Body and Lead Terminal>

### First Embodiment

As illustrated in FIG. 1, the lithium ion secondary battery is configured by a lithium ion secondary battery main body 100 and a lead terminal 200. A plurality of current collector tabs (negative electrode current collector tabs 12a, 12b, 12c, and 12d in FIG. 2) of the lithium ion secondary battery main body 100 are bundled together and welded at two joint locations: a first joint section 300 and a second joint section 400.

The structure of the connection is omitted on the positive electrode side in FIG. 1, but there can be a similar connection structure on the positive electrode side. In the present invention, the connection structure described below can be applied to either or both of the positive electrode side and the negative electrode side.

The negative electrode current collector tabs 12a, 12b, 12c, and 12d in FIG. 1 are drawn in the same direction from one end surface of the laminate in planar shapes that are approximately parallel to each other.

The number of negative electrode current collector tab is appropriately set in accordance with the number of times the unit of lamination described above is repeatedly laminated.

Subsequently, the plurality of negative electrode current collector tabs 12a, 12b, 12c, and 12d are bundled together by a conventionally known bundling means (not illustrated), such as a bundling plate or a bundling roll.

Bundling means bundling (or converging) in the side surface view of FIG. 1, and in practice means that the planar negative electrode current collector tabs 12a, 12b, 12c, and 12d are overlapped and stacked.

### [First Joint Section]

After bundling, in this embodiment, only the negative electrode current collector tabs 12a, 12b, 12c, and 12d have a first joint section 300 where they are joined.

The lead terminal 200 is not joined at this first joint section 300. In other words, in the present invention, at the first joint section 300, the current collector tabs are configured by only foil: copper foil as an example when the current collector tabs are negative electrodes, or aluminum foil as an example when the current collector tabs are positive electrodes.

Accordingly, there is no need to consider joint strength for the lead terminal 200 in the welding conditions.

Accordingly, it is possible to make the joint with welding that emphasizes the electrical joint between the negative electrode current collector tabs under weak welding conditions, and as a result it becomes possible to prevent the current collector tabs from cracking or breaking.

A first position at which the first joint section 300 is formed does not need to be directly after the bundle location if the first position is not where joining with the lead terminal 200 is performed. The first position may be any position at the bundling section, but needs to be on a front side (lithium ion secondary battery main body side) with respect to a second joint section which is described below, and is desirably directly after the bundling location.

In the present invention, the lead terminal 200 may be positioned at the first position which is at the first joint section. In this case, welding of the current collector tabs is reliably performed by performing the welding from the current collector tab side (from the top side in FIG. 1) after bundling.

### [Second Joint Section]

The plurality of current collector tabs joined at the first joint section 300 are further extended in a bundled state or an approximately bundled state to the lead terminal 200 side.

A second joint section 400 is formed at a second position where there is overlap with one end side (the lithium ion secondary battery main body side) of the lead terminal 200, which is the destination of the extension.

In other words, the bundled plurality of negative electrode current collector tabs 12a, 12b, 12c, and 12d are joined by welding to the lead terminal 200 at the second joint section 400.

Because an electrical joint between the negative electrode current collector tabs has already been achieved at the first joint section, in comparison to the abovementioned joint section 600 that uses a conventional technique, stronger welding conditions can be applied at the second joint section 400 as long as physical strength is maintained by strongly joining the current collector tabs and the lead terminal 200.

Because an electrical joint between the negative electrode current collector tabs is already achieved at the first joint section, it is sufficient if only some current collector tabs of the plurality of current collector tabs are joined to the lead terminal 200 at the second joint section 400.

At the second joint section, welding between the lead terminal and the current collector tabs is reliably performed by performing the welding from the lead terminal side (from the lower side in FIG. 1).

In this embodiment, as a result of separately providing the first joint section and the second joint section, an interposition section configured by only the bundled current collector tabs is formed between the first joint section and the second joint section.

By this, even if the other end side of the lead terminal deviates vertically in FIG. 1, it is possible to prevent a load being applied to the first joint section 300 by the interposition section bending.

In the present invention, another joint section such as a third joint section may be further provided between the first joint section and the second joint section.

By this, it is possible to maintain the bundled state or approximately bundled state of the current collector tabs.

Joining in the present invention means joining in a broad sense that includes welding. Welding here includes fusion welding, pressure welding, and brazing, and is a joining method in which heat or pressure or both heat and pressure are applied to a joint section between two or more members, an appropriate filler material is applied if necessary, and the joint section is made to be one integrated member that has continuity.

### Second Embodiment

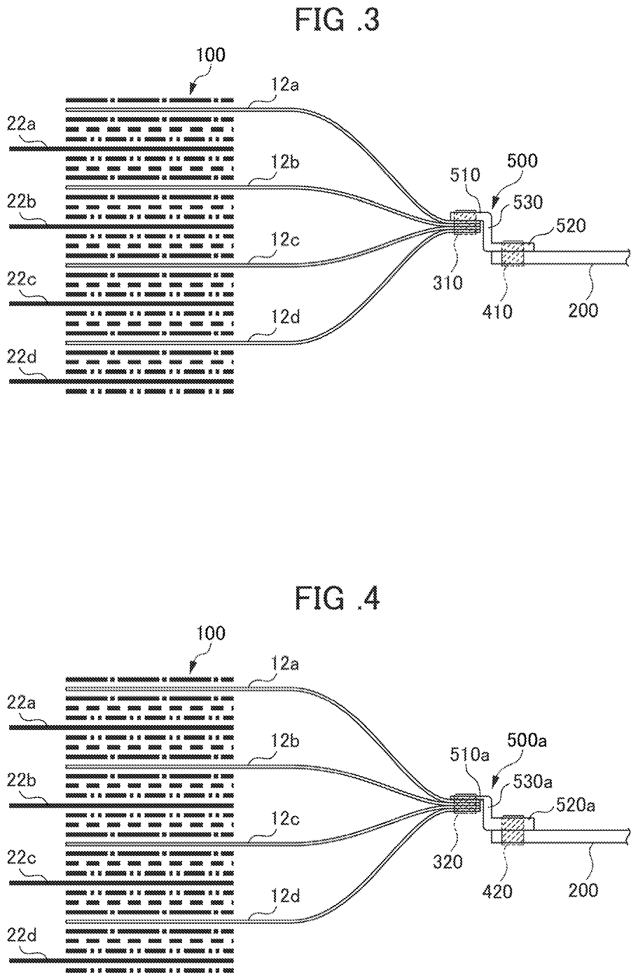

As illustrated in FIG. 3, this embodiment differs from the first embodiment described above in that current collector tabs and a lead terminal are joined, via a connection member 500.

In description of the following embodiments, similar reference symbols as in FIG. 1 are applied to configurations similar to those in FIG. 1, and description thereof is omitted.

In FIG. 3, a first joint section 310 is formed at a first position where a bundled plurality of negative electrode current collector tabs 12a, 12b, 12c, and 12d and one end side of the connection member 500 overlap.

A second joint section 410 is formed at a second position where the other end side of the connection member 500 and a lead terminal 200 overlap.

The connection member 500 is a plate-like member that, as a whole, has a predetermined width, has an approximately rectangular shape in a plan view, and has a step at the approximate center of the connection member 500.

The connection member 500 includes a first planar section 510 at which the first joint section 310 is formed on the current collector tab side, a second planar section 520 at which the second joint section 410 is formed on the lead terminal 200 side, and an orthogonal third planar section 530 that extends orthogonally downward from one side of the first planar section 510 and reaches one side of the second planar section 520.

In this embodiment, the first position at which the first joint section 310 is formed is on the first planar section 510, and bundled current collector tabs are joined on a back surface side (lower side in FIG. 3) of the first planar section 510.

The second position at which the second joint section 410 is formed is on the second planar section 520, and the lead terminal 200 is joined at a back surface side (lower side in FIG. 3) of the second planar section 520.

The connection member 500 is desirably a welding tip, and may include the filler material described above.

The welding tip prevents tabs from breaking or crinkling when welding a plurality of bundled tabs. A filamentary and plate-like member made of the same material as the lead terminal can be given as a specific example of the welding tip.

In the present invention, it is desirable for the connection member to have flexibility.

An effect similar to that of the first embodiment described above can be achieved by forming the first joint section 310 and the second joint section 410 with the connection member 500, which melts at a time of welding, in between.

In particular, by using a welding tip as the connection member 500, the range of welding conditions to select from for the first joint section 310 and the second joint section 410 widens further, and the welding can be more reliably performed.

In particular, in this embodiment, there ceases to be a need to extend the bundled current collector tabs to the second joint section 410, and thus there is no need to worry about breakage or the like for the current collector tabs in the welding at the second joint section 410 in particular.

In addition, by the connection member 500 having a step, the vertical distance between the first joint section 310 and the second joint section 410 in FIG. 3 can be adjusted, and, even if the other end side of the lead terminal 200 deviates in the vertical direction in FIG. 3, it is possible to prevent a load from being applied to the current collector tabs connected to the first joint section 310 by the step bending.

### Third Embodiment

As illustrated in FIG. 4, this embodiment differs from the second embodiment described above in that the thickness of a connection member 500a differs between a first planar section 510a and a second planar section 520a, specifically in that the first planar section 510a is thinner than the second planar section 520a.

In this fashion, it is possible to weaken welding conditions for a first joint section 320 by having the thickness of one end side of the connection member 500a (the thickness of the first planar section 510a where the first joint section 320 is formed) be approximately the same thickness as each of the current collector tabs to which it is joined, specifically 0.01 to 5 mm.

In addition, it is possible to strengthen welding conditions for a second joint section 420 by having the thickness of the other end side of the connection member 500a (the thickness of the second planar section 520a where the second joint section 420 is formed) be approximately the same thickness as the lead terminal 200 to which it is joined, specifically 0.01 to 5 mm.

### Fourth Embodiment

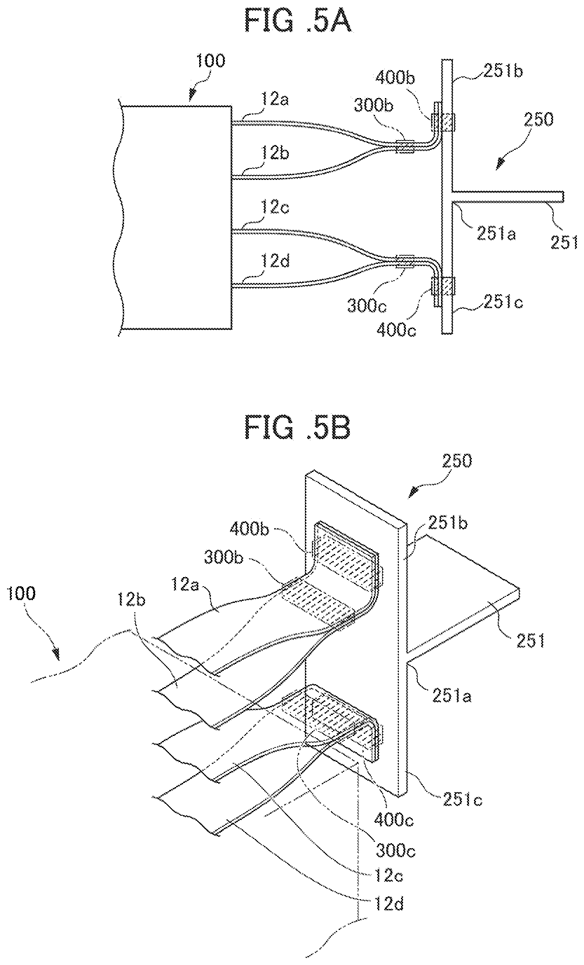

FIG. 5A and FIG. 5B are a schematic side cross-sectional view and a schematic perspective view that illustrates a state in which a lead terminal is joined to a lithium ion secondary battery main body according to a fourth embodiment of the present invention.

In this embodiment, a lead terminal 250 has a different shape.

The lead terminal 250 in FIGS. 5A and 5B has a T shape in a side surface view in FIG. 5A.

More specifically, as illustrated in FIGS. 5A and 5B, the lead terminal 250 branches by folding 90 degrees up and down from a side 251a of a base section 251 of the lead terminal, which extends parallel to the current collector tabs, and configures an upper lead terminal 251b and a lower lead terminal 251c.

The upper lead terminal 251b and the lower lead terminal 251c form a single plane, and are arranged so as to face an end surface of the lithium ion secondary battery main body 100.

The location of extension for the base section 251 of the lead terminal (in other words, the position of the side 251a) does not need to be positioned at the center of an end surface of the laminate as illustrated in FIG. 5A, and extension can be made from any position.

A second joint section 400b is formed on a surface of the upper lead terminal 251b, and a current collector tab 12a and a current collector tab 12b are bundled and joined by a first joint section 300b and subsequently folded up 90 degrees and joined by the second joint section 400b.

Similarly, a second joint section 400c is formed on a surface of the lower lead terminal 251c, and a current collector tab 12c and a current collector tab 12d are bundled and joined by a first joint section 300c and subsequently folded down 90 degrees and joined by the second joint section 400c.

In this fashion, because each current collector tab is distributed to be connected to a nearby second position, the tension applied to each current collector tab can be made to be more uniform, and it is possible to prevent the current collector tabs from cracking or breaking.

Because it is also possible to have the length of each current collector tab be approximately the same, it is possible to reduce variation in energy density for each cell due to current collection loss.

The nearby second position does not need to be at the shortest distance.

### Fifth Embodiment

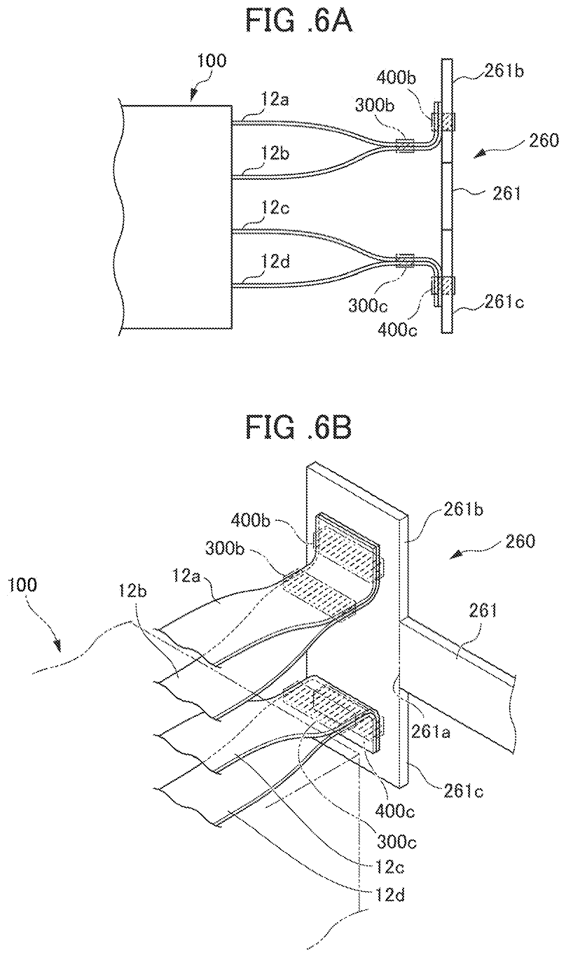

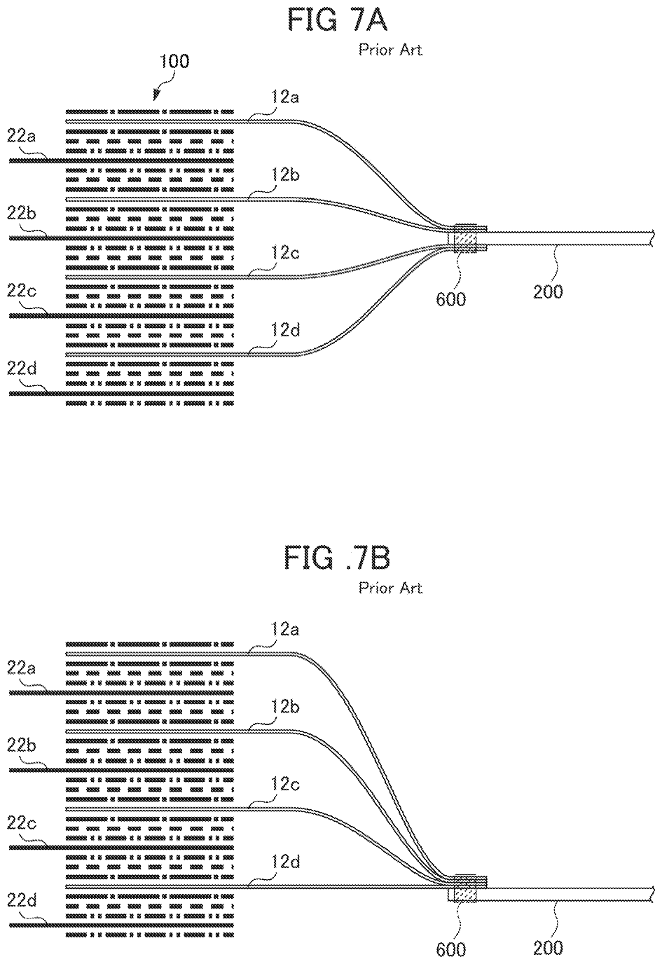

FIG. 6A and FIG. 6B are a schematic side cross-sectional view and a schematic perspective view that illustrates a state in which a lead terminal is joined to a lithium ion secondary battery main body according to a fifth embodiment of the present invention.

In this embodiment, a lead terminal 260 has a different shape.

The lead terminal 260 in FIGS. 6A and 6B has a planar T shape overall as illustrated in FIG. 6B, and is arranged to face an end surface of the lithium ion secondary battery main body 100.

More specifically, a base section 261 of the lead terminal that extends on the front side of the paper surface in FIGS. 6A and 6B branches into an upper lead terminal 261b and a lower lead terminal 261c from a virtual side 261a indicated by a broken line in FIG. 6B. The upper lead terminal 261b, the lower lead terminal 261c, and the lead terminal base 261 form a single plane, and are arranged so as to face the end surface of the lithium ion secondary battery main body. There is an advantage in that the direction in which the lead terminal base section 261 extends is not limited to the direction indicated in FIGS. 6A and 6B, and can extend in any direction from the plane that faces the end surface of the lithium ion secondary battery main body.

A second joint section 400b is formed on a surface of the upper lead terminal 261b, and a current collector tab 12a and a current collector tab 12b are bundled and joined by a first joint section 300b and subsequently folded up 90 degrees and joined by the second joint section 400b.

Similarly, a second joint section 400c is formed on a surface of the lower lead terminal 261c, and a current collector tab 12c and a current collector tab 12d are bundled and joined by a first joint section 300c and subsequently folded down 90 degrees and joined by the second joint section 400c.

The direction of the fold from the first joint section to the second joint section is discretionary.

It is also the case in this embodiment that, because each current collector tab is distributed to be connected to a nearby second position, the tension applied to each current collector tab can be made to be more uniform, and it is possible to prevent the current collector tabs from cracking or breaking.

Because it is also possible to have the length of each current collector tab be approximately the same, it is possible to reduce variation in energy density for each cell due to current collection loss due to differences in the lengths of current collector tabs.

In this embodiment, the nearby second position also does not need to be at the shortest distance.

In the fourth and fifth embodiments described above, description was given of examples in which current collector tabs are directly joined to a lead terminal, but the present invention is not limited to this, and current collector tabs may be joined to a lead terminal through a connection member described above.

In this case, it is desirable for the connection member to have flexibility.

### EXPLANATION OF REFERENCE NUMERALS

10 Negative electrode
11 Negative electrode active material layer
12 Negative electrode current collector
12a, 12b, 12c, 12d Negative electrode current collector tab
20 Positive electrode
21 Positive electrode active material layer
22 Positive electrode current collector
22a, 22b, 22c, 22d Positive electrode current collector tab
30 Solid electrolyte layer
100 Lithium ion secondary battery main body
200 Lead terminal
250, 260 Lead terminal
251, 261 Base section
251a, 261a Side
251b, 261b Upper lead terminal
251c, 261c Lower lead terminal
300, 310, 300b, 300c First joint section
400, 410, 400b, 400c Second joint section
500, 500a Connection member
510, 510a First planar section
520, 520a Second planar section
530, 530a Third planar section

What is claimed is:

1. A lithium ion secondary battery, comprising:
a lithium ion secondary battery main body that is a laminate in which a positive electrode having a positive electrode current collector, an electrolyte, and a negative electrode having a negative electrode current collector are repeatedly arranged, respective current collectors of at least one of the positive electrodes and the negative electrodes being drawn in respectively the same direction from an end surface of the laminate and configuring a plurality of current collector tabs;
a lead terminal connected to the plurality of current collector tabs after the plurality of current collector tabs are bundled together;
a first joint section at which at least the bundled current collector tabs are joined to each other at a first position; and
a second joint section at which the lead terminal and the bundled current collector tabs are joined at a second position different to the first joint section.

2. A lithium ion secondary battery, comprising:
a lithium ion secondary battery main body that is a laminate in which a positive electrode having a positive electrode current collector, an electrolyte, and a negative electrode having a negative electrode current collector are repeatedly arranged, respective current collectors of at least one of the positive electrodes and the negative electrodes being drawn in respectively the same direction from an end surface of the laminate and configuring a plurality of current collector tabs;
a lead terminal connected to the plurality of current collector tabs after the plurality of current collector tabs are bundled together;
a first joint section at which at least the bundled current collector tabs are joined to each other and one end side of a connection member at a first position; and
a second joint section at which the other end side of the connection member and the lead terminal are joined at a second position different to the first joint section.

3. The lithium ion secondary battery according to claim 2, wherein the connection member is a welding tip.

4. The lithium ion secondary battery according to claim 2, wherein the connection member is a plate-like member having a step at an approximate center of the connection member.

5. The lithium ion secondary battery according to claim 2, wherein the connection member is a plate-like member that has flexibility.

6. The lithium ion secondary battery according to claim 2, wherein the thickness of the one end side of the connection member is thinner than the thickness of the other end side.

7. The lithium ion secondary battery according to claim 2, wherein
a joint surface is arranged at one end side of the lead terminal so as to face the end surface of the laminate, and
a plurality of the second position are provided on the joint surface, and each current collector tab is distributed so as to be connected to a nearby second position, either directly or through the connection member.

8. The lithium ion secondary battery according to claim 7, wherein the one end side of the lead terminal branches into a plurality of branch destinations, and the plurality of second positions are provided on the plurality of branch destinations.
